(19) United States
(12) Patent Application Publication
(10) Pub. No.: US 2007/0229853 A1
(43) Pub. Date: Oct. 4, 2007

(54) Nanometer contact detection method and apparatus for precision machining

(75) Inventor: Chen-Hsiung Cheng, Westford, MA (US)

Correspondence Address: RATNERPRESTIA, P.O. BOX 980, VALLEY FORGE, PA, 19482, US

(73) Assignee: Matsushita Electric Industrial Co., Ltd.

(21) Appl. No.: 11/391,171

(22) Filed: Mar. 28, 2006

(51) Int. Cl. G01B 11/14

(52) U.S. Cl. 356/625

(57) ABSTRACT

A method and apparatus for determining the distance between the tip of a machining tool formed of a substantially transmissive material and a surface. A beam of narrow bandwidth light is diffracted by directing the beam of narrow bandwidth light between the surface and the tip of the machining tool such that a portion of the diffracted beam is optically coupled into the machining tool via near-field optically coupling. The power of the portion of the diffracted beam optically coupled into the machining tool is measured. The distance between the tip of the machining tool and the surface is then determined based on the measured power.

### FIELD OF THE INVENTION

The present invention concerns surface contact detection for precision machining. In particular, surface contact detection methods that may by used in precision machining processes to determine surface contact of machining tools with nanometer accuracy to provide high precision surface profiles of microstructures.

### BACKGROUND OF THE INVENTION

Diamond machining offers high accuracy and surface finish, and is suitable for fabricating optical-grade molds for making optical components, such as lenses and gratings. For example, diamond tools may be used to machine Ni molds for making gratings used in optical pickup devices. Diamond turning, fly-cutting, vibration assisted machining (VAM), slow tool servo (STS), and fast tool servo (FTS) are a few precision diamond machining methods that may be used. It is noted that a number of other machining tool materials exist as well. An important consideration in all of these precision machining methods is a means of detecting the position of the tip of the machining tool relative to the surface of the workpiece.

Conventionally, a contact method is used to determine the separation between the tip of the machining tool and the surface. In this method the tool is moved toward the surface until enough mechanical force is sensed to indicate that the tool is in contact with the surface. The tip is usually moved beyond initial contact to exert sufficient mechanical force for detection. Thus, the surface may be gouged during this procedure.

Electrical contact methods may reduce the mechanical force that is applied to the surface, however the signal to noise ratio of these methods may be less than desirable due to the poor electrical conductivity of many of the machining tools materials such as diamond. Optical imaging methods also exist, but their precision is limited by the wavelength used and may be about 0.5 microns or more. Interferometry methods may allow greater precision when used with a solid reference surface, although these methods may require a complex preparation process.

### SUMMARY OF THE INVENTION

An exemplary embodiment of the present invention is a method of determining the distance between the tip of a machining tool formed of a substantially transmissive material and a surface. A beam of narrow bandwidth light is diffracted by directing the beam of narrow bandwidth light between the surface and the tip of the machining tool such that a portion of the diffracted beam is optically coupled into the machining tool via near-field optically coupling. The power of the portion of the diffracted beam optically coupled into the machining tool is measured. The distance between the tip of the machining tool and the surface is then determined based on the measured power.

Another exemplary embodiment of the present invention is a method of determining the distance between the tip of a machining tool formed of a substantially transmissive material and a surface. A beam of light having a narrow bandwidth is optically coupled into the machining tool through a coupling surface of the machining tool. A portion of the beam of narrow bandwidth light is emitted from the tip of the machining tool into a near-field mode of a space between the tip of the machining tool and the surface. The power of the near-field mode portion of the beam of narrow bandwidth light emitted depends on the distance between the tip of the machining tool and the surface. A parameter related to the power of the near-field mode portion of the beam of narrow bandwidth light in the space between the tip of the machining tool and the surface is measured. The distance between the tip of the machining tool and the surface is determined based on the measured parameter.

An additional exemplary embodiment of the present invention is a precision machining system adapted to accurately determine the distance between the tip of a machining tool and the surface of a workpiece. The precision machining system includes: a workpiece holder to hold the workpiece for machining; the machining tool; movement stages coupled to the workpiece holder and/or the machining tool; a light source; a detector optically coupled to a coupling surface of the machining tool; and a processor electrically coupled to the detector. The machining tool, which includes the tip and the coupling surface substantially opposite the tip, is formed of a substantially transmissive material. The movement stages control the relative position of the tip of the machining tool and the surface of the held workpiece. The light source is adapted to direct a beam of light having a narrow bandwidth between the tip of the machining tool and the surface of the held workpiece. The beam of narrow bandwidth light is directed such that a portion of the beam is diffracted and optically coupled the machining tool via near-field optically coupling. The detector optically detects the power of the portion of the beam of narrow bandwidth light optically coupled into the machining tool and produces a signal corresponding to the detected power. This signal is received by the processor, which then determines the distance between the tip of the machining tool and the surface of the workpiece based on the signal.

A further exemplary embodiment of the present invention is a precision machining system adapted to accurately determine the distance between the tip of a machining tool and the surface of a workpiece. The precision machining system includes: a workpiece holder to hold the workpiece for machining; the machining tool; movement stages coupled to the workpiece holder and/or the machining tool; a light source; a detector optically coupled to the space between the tip of the machining tool and the surface; and a processor electrically coupled to the detector. The machining tool, which includes the tip and a coupling surface substantially opposite the tip, is formed of a substantially transmissive material. The movement stages control the relative position of the tip of the machining tool and the surface of the held workpiece. The light source is adapted to optically couple a beam of light having a narrow bandwidth into the machining tool through the coupling surface of the machining tool. The detector is adapted to detect the power of a portion of the beam of narrow bandwidth light emitted from the tip of the machining tool into a near-field mode of the space between the tip of the machining tool and the surface. The detector produces a signal corresponding to the detected power. This signal is received by the processor, which then determines the distance between the tip of the machining tool and the surface of the workpiece based on the signal.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawing are the following figures:

FIG. 1 is a side plan drawing illustrating an exemplary precision machining system adapted to accurately determine a distance between the tip of the machining tool and the surface of the workpiece according to the present invention.

FIG. 2 is a side plan drawing of an exemplary machining tool illustrating a light beam being directed between the tip of the machining tool and the surface of the workpiece for large separations compared to the wavelength of the light beam according to the present invention.

FIG. 3 is a detail side plan drawing of the exemplary machining tool of FIG. 2 illustrating the light beam being directed between the tip of the machining tool and the surface of the workpiece for small separations compared to the wavelength of the light beam according to the present invention.

FIG. 4 is a flowchart illustrating an exemplary method of determining the distance between the tip of the machining tool and the surface of the workpiece according to the present invention.

FIG. 5 is a side plan drawing of an exemplary machining tool illustrating exemplary methods of reducing coupling of unwanted portions of the light beam into the machining tool according to the present invention.

FIG. 6 is a side plan drawing of an exemplary machining tool illustrating other exemplary embodiments of the machining tool and system according to the exemplary method of FIG. 4.

FIG. 7 is a side plan drawing illustrating another exemplary precision machining system adapted to accurately determine a distance between the tip of the machining tool and the surface of the workpiece according to the present invention.

FIG. 8 is a flowchart illustrating another exemplary method of determining the distance between the tip of the machining tool and the surface of the workpiece according to the present invention.

FIG. 9 is a side plan drawing of an exemplary machining tool illustrating an exemplary embodiment of the exemplary method of FIG. 8.

FIG. 10 is a side plan drawing of an exemplary machining tool illustrating another exemplary embodiment of the exemplary method of FIG. 8.

### DETAILED DESCRIPTION OF THE INVENTION

The present invention involves the use of a near-field based optical method that may provide relatively simple, non-contact determination of the distance between the tip of the machining tool and the surface. These exemplary methods and the associated systems may allow determination of the distance between the tip of the machining tool and the surface with nanometer accuracy.

Exemplary embodiments of the present invention involve precision machining systems adapted to accurately determine the distance between the tip of the machining tool and the surface of the workpiece and exemplary methods of using these precision machining systems. These exemplary precision machining systems and methods may be used to perform a number of different types of precision machining.

Because these exemplary methods may be used with any precision machining system, they may provide a non-contact method of determining the relative position of the tip of the machining tool and the surface of the workpiece for numerous uses. Additionally, the exemplary embodiment of the present invention may allow the distance between the tip of the machining tool and the surface of the workpiece to be determined with nanometer accuracy. Such exemplary precision machining methods may be desirable to use for the creation of a number of devices including various microstructures and optical devices.

Further, the exemplary methods of the present invention may reduce human intervention in the alignment and contact detection processes. As a result, automation of these processes may become possible. Such process automation may substantially increase the fabrication speed and, as a result, the production cycle and cost of producing high precision microstructures may, in some cases, be dramatically reduced.

It is noted that, although the exemplary machining tools of the present invention may be diamond machining tools, other substantially transmissive machining tool materials, such as sapphire, silicon carbide, tungsten carbide, or aluminum/silicon carbide metal matrix composite, may be used as well.

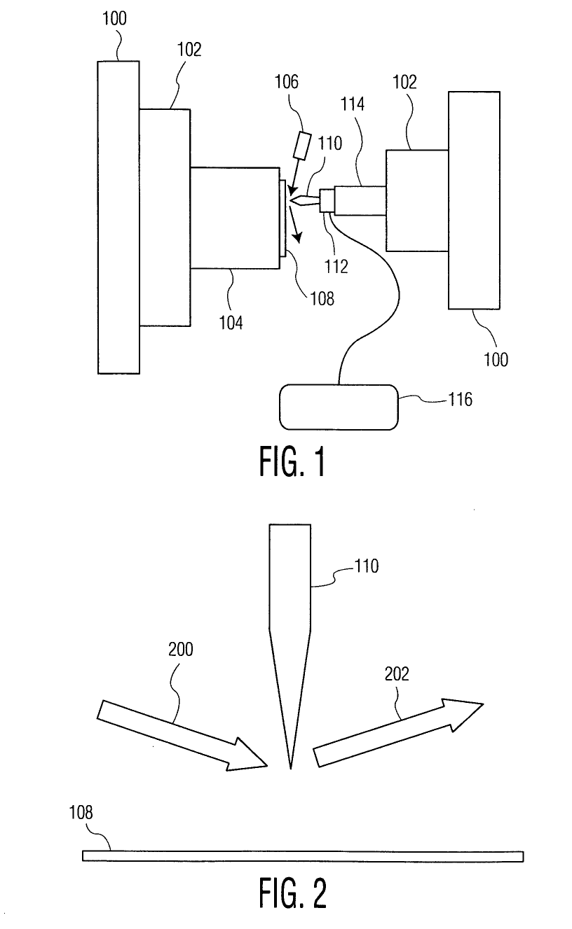

FIG. 1 illustrates an exemplary precision machining system according to the present invention. This exemplary precision machining system is designed so that the distance between the tip of machining tool 110 and the surface of workpiece 108 may be accurately determined with a precision of a few nanometers.

The exemplary precision machining system of FIG. 1 includes: base 100; motion stages 102 to move workpiece 108 and or machining tool 110 along at least one axis parallel to the surface of the workpiece and to control the relative Z position of the tip of machining tool 110 and the surface of workpiece 108; workpiece holder 104 to hold workpiece 108 during machining; machining tool holder 114 to hold machining tool 110 such that the centerline of the machining tool is substantially parallel to the Z axis of the exemplary machining system; light source 106 to direct a narrow bandwidth beam of light between the tip of machining tool 110 and the surface of workpiece 108; detector 112 to detect the power of light coupled into machining tool 110; and processor 116 to determine the distance between the tip of machining tool 110 and the surface of workpiece 108 based on a signal from detector 112.

Although FIG. 1 illustrates two movement stages 102 coupled to workpiece holder 104 machining tool holder 114, it will be understood by one skilled in the art that only one of movement stages 102 is necessary to control the relative position of the tip of the machining tool and the surface of the held workpiece. It will also be understood, however, that separate motion stages controlling motion along separate axes (X, Y, Z, Θ) may desirably be located so that workpiece 108 is moved in a subset of these axes and the machining tool is moved in the remaining axes.

Light source 106 is adapted to direct a beam of light having a narrow bandwidth between the tip of machining tool 110 and the surface of held workpiece 108. The narrow bandwidth light may desirably have a peak wavelength in the visible range, about 400 nm to about 700 nm, however, other wavelength ranges, shorter or longer, may be desirable depending on the transmission spectrum of the material of machining tool 110. For example, it may be desirable to use an infrared light source if a tungsten carbide machining tool is used, due to the relative opacity of tungsten carbide to visible light. Although the peak wavelength of light emitted by light source 106 may affect the precision of the exemplary measurement techniques of the present invention, because of the exponential dependence of near field coupling, precisions of a percent of the peak wavelength or less may be achieved. Thus, nanometer range precisions may be achieved using relatively long peak wavelength light sources, such as 1.5 μm semiconductor lasers.

It is noted that light source 106 is not shown to be mechanically coupled to the rest of the exemplary precision machining system in FIG. 1. It is contemplated that light source 106 may desirably be mechanically coupled to any one of base 100, workpiece holder 104, or machining tool holder 114. Further, light source 106 may include a light emitting element, such as a laser or a light emitting diode, and optics to direct beam 200 of narrow bandwidth light generated by the light emitting element between the tip of machining tool 110 and the surface of the held workpiece 108 as shown in FIG. 2. These optics may include a number of elements including free space optics, optical fibers, and/or planar waveguides. In this latter case, the light emitting element and the optical may be mechanically coupled to different components of the exemplary precision machining system.

The air gap between the tip of machining tool 110 and the surface of workpiece 108 generates diffraction of light passing through this gap (i.e. single slit diffraction). Strong diffraction at large angles may occur when the width of the air gap approaches half of the wavelength, or less, of the light being diffracted. Thus, if the tip of machining tool 110 is far from the surface of workpiece 108, relative to the wavelength of narrow bandwidth light beam 200, as shown in FIG. 2, the transmitted beam 202 has little diffraction at large angles.

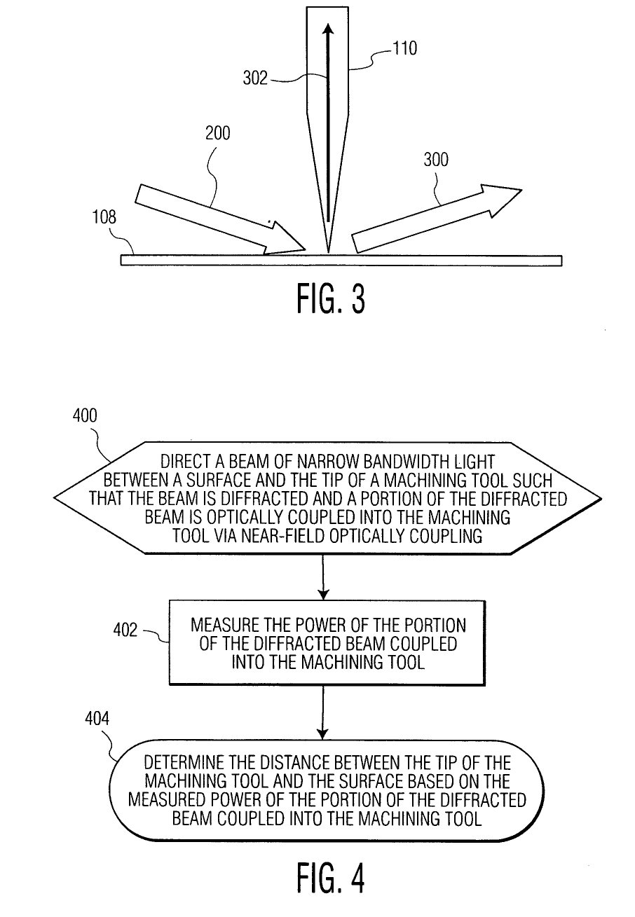

If, however, the tip of machining tool 110 is close enough to the surface of workpiece 108, as shown in FIG. 3, diffracted beam 300 may have a significant amount of large angle diffraction. A portion of the part of diffracted beam 300 that is diffracted at large angles may be incident on the tip of machining tool 110. Under free space conditions very little of this light is likely to be coupled into machining tool, particularly given the high refractive indices of materials commonly used in machining tool, such as diamond, sapphire, silicon carbide, aluminum/silicon carbide metal matrix composite, tungsten carbide, etc. However, because of the proximity of the surface of workpiece 108, near field effects may increase the optical coupling of this diffracted light. The combination of increased large angle diffraction and near-field optical coupling effects occur, for example, when the tip of machining tool 110 and the surface are less than half of the peak wavelength of light beam 200. Under these conditions, coupled light beam 302 may have enough power to be easily detected. Further, because near-field optical coupling effects vary exponentially with separation, the power of coupled light beam 302 may vary significantly for small changes in the distance between the tip of machining tool 110 and the surface of workpiece 108, allowing high precision measurements of this distance. (It is noted that the power of coupled light beam 302 should vary more rapidly than exponentially due to the additional effect of the large angle diffraction variation.)

Once the light is coupled into machining tool 110, the high refractive index of the machining tool material helps to confine the coupled diffraction light within the machining tool because of total internal reflection.

It is noted that, although detector 112 may be any type of optical detector, it may be desirable for detector 112 to be an optical detector adapted to preferentially detect light having the narrow bandwidth of light beam 200, and coupled diffraction light 302. Such a narrow bandwidth optical detector may achieve an improved signal to noise ratio by filtering out stray ambient light that may become coupled into machining tool 110.

It is also noted that detector 112 is shown in FIG. 1 to be directly connected to the butt surface of machining tool 110 and also to be mechanically coupled to machining tool holder 114. This configuration is shown for illustrative purposes, however it is contemplated that detector 112 may be mechanically coupled to the exemplary machining system in other locations, such as to the side of machining tool holder 114 or to base 100, detector 112 is desirably optically coupled to the butt surface, or another coupling surface of machining tool 110 configured for optically coupling light out of the machining tool that was optically coupled into the machining tool through the tip. If located at a position other than on the butt surface of machining tool 110, detector 112 may be optically coupled to the coupling surface of machining tool 110 using optics such as free space optics, optical fibers, and/or planar waveguides. Design of the coupling surface and/or the optics desirably provides for efficient optical coupling of the coupled diffraction light. This may be complicated by the refractive index of the machining tool material.

Detector 112 produces a signal corresponding to the detected power of coupled diffraction light 302. This signal is received by processor 116. Processor 116 uses this received signal to determine the distance between the tip of machining tool 110 and the surface of the workpiece 108. This processor may include one or more components such as: a general purpose computer programmed to determine the distance between the tip of the machining tool and the surface of the workpiece based on the signal received from the detector; a digital signal processor; special purpose circuitry; and/or an application specific integrated circuit. Once the detector and processor have been calibrated the exemplary precision machining system of FIG. 1 may determine the distance of the tip of machining tool 110 from the surface of workpiece 108 with a precision of a few nanometers and a similar accuracy.

FIG. 4 illustrates an exemplary method of determining the distance between the tip of a machining tool formed of a substantially transmissive material and a surface.

A beam of narrow bandwidth light is diffracted by directing the beam between the surface and the tip of the machining tool such that a portion of the diffracted beam of narrow bandwidth light is optically coupled into the machining tool via near-field optically coupling, step 400. This step is illustrated in FIG. 3. As described above with reference to FIG. 1, the beam of narrow bandwidth light may desirably be generated using a laser or a light emitting diode and may be directed using various optics. It is noted that the beam of light may be directed such that it either propagates from the front side of the tip of the machining tool to the back side of the tip or vice versa. Typically, at least a portion of the light beam is incident on both the tip of the machining tool and the surface adjacent to the tip. The amount of light incident on the tip of the machining tool may be reduced by substantially focusing the beam of light into the space between the surface and the tip of the machining tool, but if the beam is too tightly focused it may not interact sufficiently with the tip of the machining tool and the surface to produce the desired diffraction.

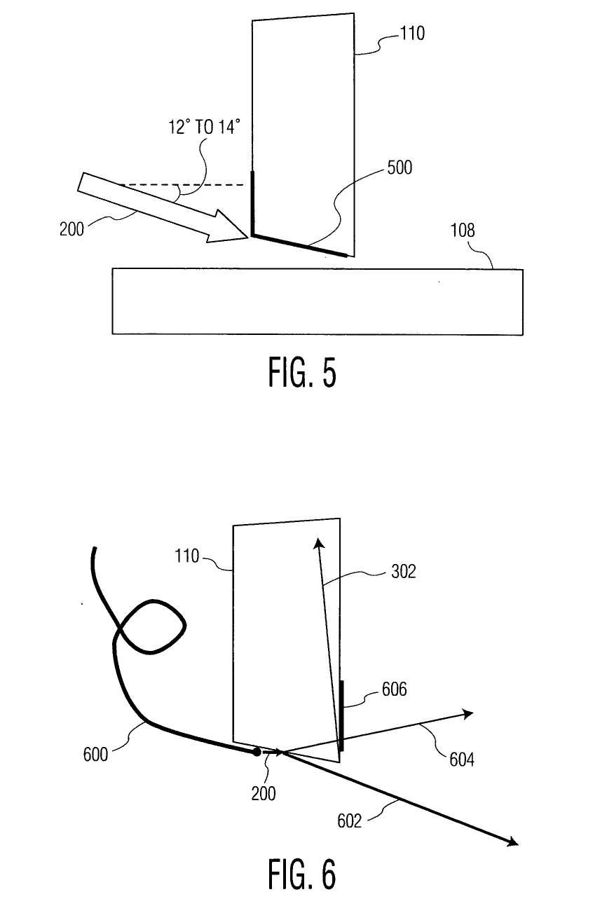

If the back surface of the machining tool is disposed at an angle close to a right angle (e.g. >˜75°) with the rake face of the machining tool near the tip, an undesirable amount of the light may be coupled into the machining tool through the back surface. This undesirable additional light may saturate the detector and, even if it does not saturate the detector, the additional light may undesirably reduce the signal to noise ratio. The beam of narrow bandwidth light, however, may desirably be directed such that part of the light beam is incident on a portion of the back surface of the machining tool, adjacent to the tip at a grazing angle. This exemplary configuration may reduce coupling of the undiffracted light through the back surface as shown in FIG. 5.

FIG. 5 illustrates light beam 200 being directed at this grazing angle of incidence relative to the back surface of machining tool 110. Additionally, the exemplary embodiment of FIG. 5 includes high reflectivity coating 500 formed on the back surface of machining tool 110 to further reduce coupling of unwanted light into the machining tool. It is noted that high reflectivity coating 500 does not extend all the way to the tip of machining tool 110 as this would interfere with the desired coupling of diffracted light through the tip and would also interfere with the machining of the surface by the tip of the machining tool. It is also noted that, although not shown in FIG. 5, a high reflectivity coating may be applied to a portion of the rake face of the machining tool to reduce coupling of unwanted light into the machining tool through the rake face. These high reflectivity coatings may be applied either surface or both as desired.

It is desirable that any coating added to the surfaces of the machining tool do not actually extend into the portion of the tip of machining tool 110 actually used for cutting. Coatings that extend into this portion of the tip may undesirably affect the cutting quality of the machining tool and may wear off with use, thereby altering the optical properties of the machining tool as well.

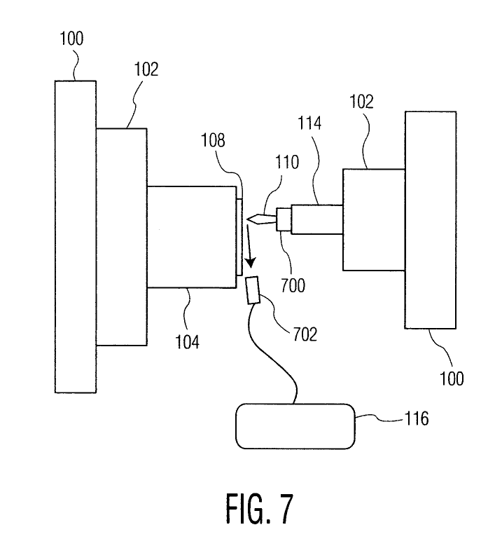

FIG. 6 illustrates another way to reduce the amount of stray light from the light source that is eventually detected by the detector. In this exemplary embodiment light beam 200 is shown being directed so as to be incident with the back surface of machining tool 110 by optical fiber 600. At the back surface of the machining tool, light beam 200 is split into a reflected portion 602 and a transmitted portion 604. Reflected portion 602 may be diffracted so that the desired near-field coupled portion 302 may be formed. Antireflection coating 606 is located so as to reduce confinement of transmitted portion 604 without significantly reducing the confinement of near-field coupled portion 302.

The power of the portion of the diffracted beam of narrow bandwidth light optically coupled into the machining tool is measured, step 402. As described above with reference to FIG. 1 a detector optically coupled to a coupling surface of the machining tool may desirably be used to measure the power of the portion of the diffracted beam of narrow bandwidth light optically coupled into the machining tool.

The distance between the tip of the machining tool and the surface is then determined, step 404, based on the power measured in step 402. As describe above with reference to FIG. 1, the relationship between the power of the diffracted light coupled into the machining tool and the distance between the tip of the machining tool and the surface may vary rapidly. Thus, high precision and accuracy may be achieved.

One significant difficulty in realizing the potential high precisions and accuracies is the signal to noise ratio of the measured power of the coupled light, which is limited by the small amplitude of the signal being measured. Dithering the coupled light signal to allow synchronous detection of the signal may increase the signal to noise ratio by filtering the noise. One method to dither the signal is to dither the power of the beam of narrow bandwidth light generated in step 400. The power of the portion of the diffracted beam of narrow bandwidth light optically coupled into the machining tool may be similarly dithered. The dither power may be measured synchronously and then the distance between the tip of the machining tool and the surface determined based on this dithered power measurement. It is noted, however that dithering the power of the beam of narrow bandwidth light may only eliminate noise from other light sources, such as ambient light.

Alternatively, the distance between the tip of the machining tool and the surface may be dithered while measuring the power of the portion of the diffracted beam of narrow bandwidth light optically coupled into the machining tool in step 402. Because of the nonlinear dependence of the coupled power to the distance between the tip of the machining tool and the surface, this method may lead to a sharply varying signal from which a background noise level may be removed. This method of dithering distance may be desired because it allows noise from any light noise that is not distance-sensing in origin to be reduced. For example, the power of any portion of the incident beam of narrow bandwidth light that is directly coupled into the machining tool through a surface of the tool is not varied as the distance is dithered, unlike the power of the portion of the diffracted beam of narrow bandwidth light optically coupled into the tip of the machining tool, which is varied as the distance is dithered.

FIG. 7 illustrates another exemplary precision machining system adapted to accurately determine the distance between the tip of the machining tool and the surface of a workpiece. Many of the features of this exemplary embodiment are identical to the exemplary embodiment of FIG. 1. In the exemplary system of FIG. 7, light source 700 is optically coupled to a coupling surface of the machining tool and couples a narrow bandwidth light beam through the surface. As in the exemplary embodiment of FIG. 1, light source 700 may include a laser or a light emitting diode to generate the narrow bandwidth light beam. Light source 700 may optically couple the light beam into machining tool 110 directly or may include optics to couple the light beam into the machining tool.

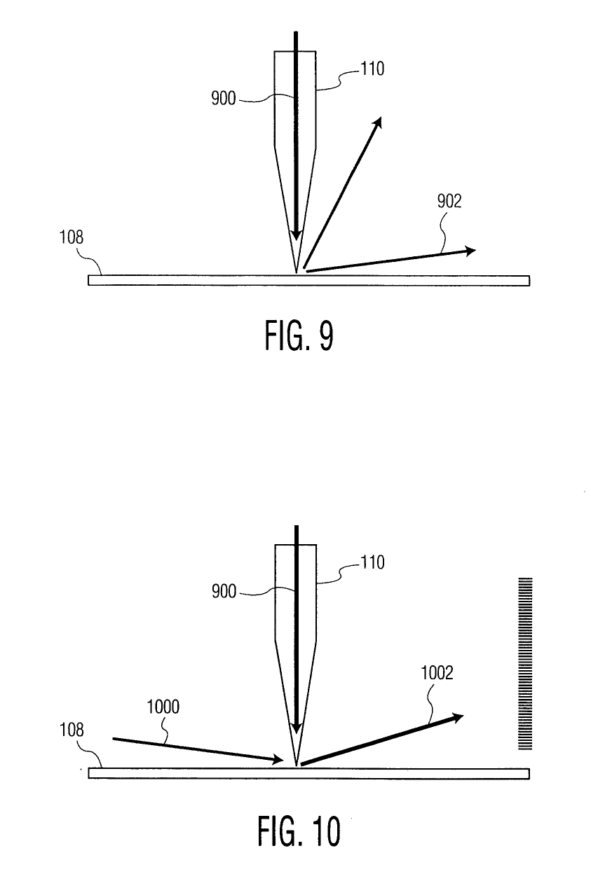

As shown in FIG. 9, when the tip of machining tool 110 is sufficiently close to the surface of workpiece 108, internal light beam 900 may be coupled out of tip of the machining tool into the space between the tip of the machining tool and the surface via near-field optical coupling. It is noted that some light may also be coupled into far-field modes. Near-field modes 902 primarily propagate along the surface, however. Thus, as shown in FIG. 7, detector 702 is desirably aligned to be optically coupled to the space between the tip of the machining tool and the surface, particularly with respect to light propagating near the surface. Additionally, machining tool 110 may also have a high reflectivity coating on its rake face and/or the back surface near the tip to reduce emission of light from the machining tool into a far-field mode.

Detector 702 is adapted to detect the power of the portion of the beam of narrow bandwidth light emitted from the tip of the machining tool into near-field mode(s) of the space between the tip of the machining tool and the surface. Detector 702 also produces a signal corresponding to the detected power. Processor 116 receives the signal produced by detector 702 and determines the distance between the tip of machining tool 110 and the surface of workpiece 108 based on the signal.

It is noted that the exemplary precision machining system of FIG. 7 may also include another light source (not shown in FIG. 7) that is coherently related to the original light source. This other light source, which is largely identical to light source 106 of FIG. 1, is adapted to direct a beam of narrow bandwidth light between the surface and the tip of machining tool 110 such that diffraction of this beam of narrow bandwidth light is enhanced by the portion of the beam of narrow bandwidth light emitted from the tip of the machining tool into the near-field mode of the space between the tip of the machining tool and the surface by the principle of coherence interference between these two beams. One exemplary method of generating the two coherently related light sources of this embodiment is to split the beam of a single narrow bandwidth light source into two sub-beams. One sub-beam is coupled into machining tool 110 as illustrated in FIG. 7, and the other sub-beam is directed between the surface and the tip of machining tool 110.

In this alternative embodiment, illustrated in FIG. 10, beam 1000 is the narrow bandwidth light beam generated by this additional light source and detector 702 is adapted to measure the power of the zero order of diffracted beam 1002 of narrow bandwidth light. This measurement may be used to detect indirectly the power of the portion of beam 900 that is emitted from the tip of machining tool 110 into a near-field mode of the space between the tip of the machining tool and the surface.

In a further alternative embodiment, acousto-optical modulation may be used to shift the frequency of one of the two coherently related beams shown in FIG. 10. Thus, the zero order of coherent interference between narrow bandwidth light beam 1000 and the portion of beam 900 emitted into a near-field mode in the space between the tip of the machining tool and the surface includes a beat note with a frequency equal to the frequency shift. The strength of this beat note is based on the intensity of the light coupled into the near-field mode and, thus, is related to the distance between the tip of the machining tool and the surface.

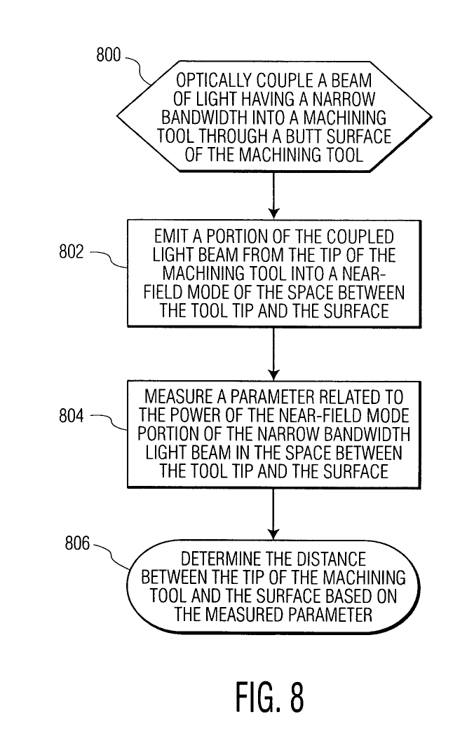

FIG. 8 illustrates another exemplary method of determining the distance between the tip of a machining tool formed of a substantially transmissive material and a surface. This exemplary method may desirably be used with the exemplary system of FIG. 7.

A beam of light having a narrow bandwidth is coupled into the machining tool through a coupling surface of the machining tool, step 800. A portion of the beam of narrow bandwidth light is emitted from the tip of the machining tool into one or more near-field modes of a space between the tip of the machining tool and the surface, step 802. Due to the nature of near-field coupling, the power of the near-field mode portion of the beam of narrow bandwidth light emitted into the near-field mode(s) depends on the distance between the tip of the machining tool and the surface.

A parameter related to the power of the near-field mode portion of the beam of narrow bandwidth light in the space between the tip of the machining tool and the surface is measured, step 804. Examples of this parameter may include the intensity of radiation in the narrow bandwidth propagating substantially along the surface of the workpiece.

Alternatively, in the exemplary embodiment of FIG. 10, another beam 1000 of light having the narrow bandwidth is directed between the surface and the tip of the machining tool such that diffraction of the other beam of narrow bandwidth light is enhanced by the portion of beam 900 emitted from the tip of the machining tool into the near-field mode of the space between the tip of the machining tool and the surface. In this embodiment, the measured parameter may be the power of the zero order of diffracted beam 1002 of narrow bandwidth light or the power contrast between the zero order and the first node of diffracted beam 1002.

In the further alternative exemplary embodiment of FIG. 10, the measured parameter may be the power of the beat note of the zero order of diffracted beam 1002 of narrow bandwidth light.

The distance between the tip of the machining tool and the surface is determined, step 806, based on the parameter measured in step 804.

This exemplary method may also include causing the power of the portion of the beam of narrow bandwidth light emitted from the tip of the machining tool into the near-field mode of the space between the tip of the machining tool and the surface in step 802 to be periodically varied either: by dithering the power of the beam of narrow bandwidth light; or by dithering the distance between the tip of the machining tool and the surface. When either of these dithering methods is used, the parameter measured in step 804 may be a periodically varying parameter that corresponds to the power of the near-field mode portion of the beam of narrow bandwidth light in the space between the tip of the machining tool and the surface. Alternatively, a relatively constant parameter may be used instead. For example, the parameter measured in step 804 may be related to: the average power of the near-field mode portion of the beam of narrow bandwidth light in the space between the tip of the machining tool and the surface; or the variation in the power of the near-field mode portion of the beam of narrow bandwidth light in the space between the tip of the machining tool and the surface during each dither cycle.

The present invention includes a number of exemplary precision machining systems and methods adapted to accurately determine the distance between the tip of the machining tool and the surface of a workpiece. Although the invention is illustrated and described herein with reference to specific embodiments, it is not intended to be limited to the details shown. Rather, various modifications may be made in the details within the scope and range of equivalents of the claims and without departing from the invention. In particular, one skilled in the art may understand that many features of the various specifically illustrated embodiments may be mixed to form additional exemplary precision machining systems and methods also embodied by the present invention.

What is claimed:

1. A method of determining a distance between a tip of a machining tool formed of a substantially transmissive material and a surface, the method comprising the steps of:
a) diffracting a beam of narrow bandwidth light by directing the beam of narrow bandwidth light between the surface and the tip of the machining tool such that a portion of the diffracted beam of narrow bandwidth light is optically coupled into the machining tool via near-field optically coupling;
b) measuring a power of the portion of the diffracted beam of narrow bandwidth light optically coupled into the machining tool; and
c) determining the distance between the tip of the machining tool and the surface based on the power measured in step (b).

2. A method according to claim 1, wherein step (a) includes the steps of:
a1) generating the beam of narrow bandwidth light using one of a laser or a light emitting diode; and
a2) directing the beam of narrow bandwidth light between the surface and the tip of the machining tool such that a portion of the diffracted beam of narrow bandwidth light is optically coupled into the machining tool via near-field optically coupling.

3. A method according to claim 2, wherein:
step (a1) includes dithering a power of the beam of narrow bandwidth light;
step (b) includes measuring a dithered power of the portion of the diffracted beam of narrow bandwidth light optically coupled into the machining tool; and
step (c) includes determining the distance between the tip of the machining tool and the surface based on the dithered power measured in step (b).

4. A method according to claim 1, wherein step (a) includes directing the beam of narrow bandwidth light such that the beam of narrow bandwidth light is incident on a portion of a back surface of the machining tool adjacent to the tip at a grazing angle.

5. A method according to claim 1, wherein step (a) includes substantially focusing the beam of narrow bandwidth light between the surface and the tip of the machining tool.

6. A method according to claim 1, wherein step (a) includes using at least one of free space optics, an optical fiber, or a planar waveguide to direct the beam of narrow bandwidth light between the surface and the tip of the machining tool.

7. A method according to claim 1, wherein step (b) includes using a detector optically coupled to a coupling surface of the machining tool to measure the power of the portion of the diffracted beam of narrow bandwidth light optically coupled into the machining tool.

8. A method according to claim 1, further comprising the step of:
d) dithering the distance between the tip of the machining tool and the surface while measuring the power of the portion of the diffracted beam of narrow bandwidth light optically coupled into the machining tool in step (b);
wherein the distance between the tip of the machining tool and the surface is determined in step (c) based on the dithered power measured in step (b).

9. A method of determining a distance between a tip of a machining tool formed of a substantially transmissive material and a surface, the method comprising the steps of:
a) optically coupling a beam of light having a narrow bandwidth into the machining tool through a coupling surface of the machining tool;
b) emitting a portion of the beam of narrow bandwidth light from the tip of the machining tool into a near-field mode of a space between the tip of the machining tool and the surface, a power of the near-field mode portion of the beam of narrow bandwidth light emitted depending on the distance between the tip of the machining tool and the surface;
c) measuring a parameter related to the power of the near-field mode portion of the beam of narrow bandwidth light in the space between the tip of the machining tool and the surface; and
d) determining the distance between the tip of the machining tool and the surface based on the parameter measured in step (c).

10. A method according to claim 9, wherein step (a) includes the steps of:
a1) generating the beam of narrow bandwidth light using one of a laser or a light emitting diode; and
a2) optically coupling the beam of narrow bandwidth light into the machining tool through the coupling surface of the machining tool.

11. A method according to claim 9, wherein step (a) includes dithering the beam of narrow bandwidth light in power, whereby the power of the portion of the beam of narrow bandwidth light emitted from the tip of the machining tool into the near-field mode of the space between the tip of the machining tool and the surface in step (b) is periodically varied.

12. A method according to claim 11, wherein:
the parameter measured in step (c) periodically varies corresponding to the power of the near-field mode portion of the beam of narrow bandwidth light in the space between the tip of the machining tool and the surface; and
step (d) includes determining the distance between the tip of the machining tool and the surface based on the periodically varying parameter measured in step (c).

13. A method according to claim 11, wherein the parameter measured in step (c) is related to at least one of:
an average power of the near-field mode portion of the beam of narrow bandwidth light in the space between the tip of the machining tool and the surface; or
a variation in the power of the near-field mode portion of the beam of narrow bandwidth light in the space between the tip of the machining tool and the surface during each dither cycle.

14. A method according to claim 9, wherein step (a) includes using at least one of free space optics, an optical fiber, or a planar waveguide to optically couple the beam of narrow bandwidth light into the machining tool through the coupling surface of the machining tool.

15. A method according to claim 9, wherein step (b) includes dithering the distance between the tip of the machining tool and the surface to periodically vary the power of the portion of the beam of narrow bandwidth light emitted into the near-field mode of the space between the tip of the machining tool and the surface.

16. A method according to claim 15, wherein:
the parameter measured in step (c) periodically varies corresponding to the power of the near-field mode portion of the beam of narrow bandwidth light in the space between the tip of the machining tool and the surface; and
step (d) includes determining the distance between the tip of the machining tool and the surface based on the periodically varying parameter measured in step (c).

17. A method according to claim 15, wherein the parameter measured in step (c) is related to at least one of:
an average power of the near-field mode portion of the beam of narrow bandwidth light in the space between the tip of the machining tool and the surface; or
a variation in the power of the near-field mode portion of the beam of narrow bandwidth light in the space between the tip of the machining tool and the surface during each dither cycle.

18. A method according to claim 9, wherein the parameter measured in step (c) is an intensity of radiation in the narrow bandwidth propagating substantially along the surface.

19. A method according to claim 9, wherein:
step (c) includes the steps of:
c1) directing an other beam of light coherently related to the beam of narrow bandwidth light between the surface and the tip of the machining tool such that diffraction of the other beam of light is enhanced by the portion of the beam of narrow bandwidth light emitted from the tip of the machining tool into the near-field mode of the space between the tip of the machining tool and the surface in step (b); and
c2) measuring a power of a zero order of the diffracted other beam of light; and
step (d) includes determining the distance between the tip of the machining tool and the surface based on the zero order power of the diffracted other beam of light measured in step (c2).

20. A method according to claim 9, wherein:
step (c) includes the steps of:
c1) directing an other beam of light coherently related to the beam of narrow bandwidth light between the surface and the tip of the machining tool such that diffraction of the other beam of light is enhanced by the portion of the beam of narrow bandwidth light emitted from the tip of the machining tool into the near-field mode of the space between the tip of the machining tool and the surface in step (b); and
c2) measuring a power contrast between a zero order and a first node of the diffracted other beam of light; and
step (d) includes determining the distance between the tip of the machining tool and the surface based on the zero order power contrast of the diffracted other beam of light measured in step (c2).

21. A method according to claim 9, wherein:
step (c) includes the steps of:
c1) directing an other beam of light, which is coherently related to and frequency shifted from the beam of narrow bandwidth light, between the surface and the tip of the machining tool such that a zero order of the diffracted other beam of narrow bandwidth light includes a beat note; and
c2) measuring a power of the beat note of the zero order of the diffracted other beam of narrow bandwidth light;
step (d) includes determining the distance between the tip of the machining tool and the surface based on the beat note power of the zero order of the diffracted other beam of narrow bandwidth light measured in step (c2).

22. A precision machining system adapted to accurately determine a distance between a tip of a machining tool and a surface of a workpiece, the precision machining system comprising:
a workpiece holder to hold the workpiece for machining;
the machining tool formed of a substantially transmissive material, the machining tool including the tip and a coupling surface substantially opposite the tip;
movement stages coupled to at least one of the workpiece holder or the machining tool to control a relative position of the tip of the machining tool and the surface of the held workpiece;
a light source adapted to direct a beam of light having a narrow bandwidth between the tip of the machining tool and the surface of the held workpiece such that a portion of the beam of narrow bandwidth light is diffracted and optically coupled the machining tool via near-field optically coupling;
a detector optically coupled to the coupling surface of the machining tool to detect a power of the portion of the beam of narrow bandwidth light optically coupled into the machining tool and produce a signal corresponding to the detected power; and
a processor electrically coupled to the detector to receive the signal produced by the detector and determine the distance between the tip of the machining tool and the surface of the workpiece based on the signal.

23. A precision machining system according to claim 22, wherein:
the substantially transmissive material of the machining tool is one of diamond, sapphire, silicon carbide, tungsten carbide, or aluminum/silicon carbide metal matrix composite.

24. A precision machining system according to claim 22, wherein:
the machining tool further includes a rake face and a back surface opposite the rake face; and
at least one of the rake face or the back surface has a high reflectivity coating on a surface portion near the tip to reduce coupling into the machining tool of light other than the near-field optically coupled portion of the diffracted beam of narrow bandwidth light.

25. A precision machining system according to claim 22, wherein:
the machining tool further includes a rake face and a back surface opposite the rake face; and
at least one of the rake face or the back surface has an anti-reflection coating on a surface portion near the tip to reduce confinement of light other than the near-field optically coupled portion of the diffracted beam of narrow bandwidth light in the machining tool.

26. A precision machining system according to claim 22, wherein the light source is one of a laser or a light emitting diode.

27. A precision machining system according to claim 22, wherein:
the light source includes optics to direct the beam of narrow bandwidth light between the tip of the machining tool and the surface of the held workpiece; and
the optics include at least one of free space optics, an optical fiber, or a planar waveguide.

28. A precision machining system according to claim 2, wherein the detector an optical detector adapted to detect light having the narrow bandwidth.

29. A precision machining system according to claim 22, wherein the detector is optically coupled to the coupling surface of the machining tool by at least one of free space optics, an optical fiber, or a planar waveguide.

30. A precision machining system according to claim 22, wherein the processor includes at least one of:
a general purpose computer programmed to determine the distance between the tip of the machining tool and the surface of the workpiece based on the signal received from the detector;
a digital signal processor;
special purpose circuitry; or
an application specific integrated circuit.

31. A precision machining system adapted to accurately determine a distance between a tip of a machining tool and a surface of a workpiece, the precision machining system comprising:
a workpiece holder to hold a workpiece for machining;
the machining tool formed of a substantially transmissive material, the machining tool including the tip and a coupling surface substantially opposite the tip;
movement stages coupled to at least one of the workpiece holder or the machining tool to control a relative position of the tip of the machining tool and the surface of the held workpiece;
a light source adapted to optically couple a beam of light having a narrow bandwidth into the machining tool through the coupling surface of the machining tool;
a detector optically coupled to a space between the tip of the machining tool and the surface adapted to:
detect a power of a portion of the beam of narrow bandwidth light emitted from the tip of the machining tool into a near-field mode of the space between the tip of the machining tool and the surface; and
produce a signal corresponding to the detected power; and
a processor electrically coupled to the detector to receive the signal produced by the detector and determine the distance between the tip of the machining tool and the surface of the workpiece based on the signal.

32. A precision machining system according to claim 31, wherein:
the substantially transmissive material of the machining tool is one of diamond, sapphire, silicon carbide, tungsten carbide, or aluminum/silicon carbide metal matrix composite.

33. A precision machining system according to claim 31, wherein:
the machining tool further includes a rake face and a back surface opposite the rake face; and
at least one of the rake face or the back surface has a high reflectivity coating on a surface portion near the tip to reduce emission of light from the machining tool into a far-field mode.

34. A precision machining system according to claim 31, wherein the light source is one of a laser or a light emitting diode.

35. A precision machining system according to claim 31, wherein:
the light source includes optics to optically couple the beam of narrow bandwidth light into the coupling surface of the machining tool; and
the optics include at least one of free space optics, an optical fiber, or a planar waveguide.

36. A precision machining system according to claim 31, wherein the detector includes an optical detector adapted to detect light having the narrow bandwidth.

37. A precision machining system according to claim 31, wherein the detector is optically coupled to the space between the tip of the machining tool and the surface by at least one of free space optics, an optical fiber, or a planar waveguide.

38. A precision machining system according to claim 31, wherein the processor includes at least one of:
a general purpose computer programmed to determine the distance between the tip of the machining tool and the surface of the workpiece based on the signal received from the detector;
a digital signal processor;
special purpose circuitry; or
an application specific integrated circuit.

39. A precision machining system according to claim 31:
further comprising another light source adapted to direct another beam of light that is coherently related to the beam of narrow bandwidth light between the surface and the tip of the machining tool;
wherein the detector is adapted to detect the power of the portion of the beam of narrow bandwidth light emitted from the tip of the machining tool into a near-field mode of the space between the tip of the machining tool and the surface by measuring a zero order of the diffracted other beam of light.
